(19) United States
(12) Patent Application Publication
(10) Pub. No.: US 2011/0158771 A1
(43) Pub. Date: Jun. 30, 2011

(54) MULTIPLE LEGGED NAIL AND MULTIPLE LEGGED NAIL INSERTION DEVICE

(76) Inventor: Yaakov Zvi Davidovitch, Ramat-Gan (IL)

(21) Appl. No.: 13/060,059

(22) PCT Filed: Aug. 19, 2009
(86) PCT No.: PCT/IB09/53654

§ 371 Date: Feb. 22, 2011

Related U.S. Application Data
(60) Provisional application No. 61/136,222, filed on Aug. 19, 2008.

(51) Int. Cl. F16B 15/00

(52) U.S. Cl. 411/457

(57) ABSTRACT

A multiple legged nail (100) whose legs (11) are shaped with slopes (13) which ensure that when inserted into a panel, such as a wood or plaster panel, the legs (11) will bend outwards in order to achieve good grip of the panel, while keeping the head (16) of the nail at the desired angle with the panel, and a multiple legged nail insertion device (200), which includes a handle (24), a cylindrical guide (23), and an internal hammer, and which enables the insertion of multiple legged nail (100), with ease and precision, and without incurring any damage to it. Optionally the multiple legged nail (100) has a shoulder disc (14) having two planes to which the legs are attached on the first plane, in which the shoulder disc (14) is conical on the second plane. A plurality of such nails may optionally support a plate (1000), for example by being inserted through holes in said plate.

### FIELD OF THE INVENTION

The present invention relates to nails, more particularly, to a multiple legged nail and to a multiple legged nail insertion device.

### BACKGROUND OF THE INVENTION

Panels made of various materials such as wood or plaster, (AKA drywall) are commonly used for various purposes such as building structures. Often such panels need to be connected to each other, and one of the common ways of doing this is by means of nails. Furthermore, there is also a need to hang various objects such as pictures, cabinets, and shelves and to connect various items to such panels, for example paper notes. Other than nails, thumbtacks and screws, screwed into dowel anchors inserted into drill holes in walls, also serve for these purposes.

The internal structure of plaster panels and panels that are not uniform in structure, such as fibrous wood panels, often cause nails to shift from the desired direction when being inserted.

FIG. 1a of the prior art is a side view schematic illustration of the standard practice of inserting a nail into a wood panel, with the nail held in one hand and a hammer to hit the head of the nail held in the other hand. FIG. 1b of the prior art depicts how a regular nail might bend due to a slight deviation of the axis of force from the hit by the hammer with regard to the nail's axis.

When the material into which the nail is inserted is too soft, e.g. chipboard or plaster, the nail's grip in that material is very loose. This may be the case also when a screw is screwed into a soft material. Dowel anchors may solve this problem in case of plaster, for example, but on the expense of higher handling complexity. It also does not provide a complete, strong solution.

When a nail is inserted into a plate bundle the plates tend to detach over time. When such plates are connected by means of a screw the screw length is selected such that its tip would be within the last plate. An insufficiently long screw wouldn't attach to the last layer, as depicted in FIG. 1c, while a screw that is too long protrudes out from the last layer, as depicted in FIG. 1d.

There is thus a widely recognized need for, and it would be highly advantageous to have a new nail and an insertion device to replace nails, screws and thumbtacks that are presently in use without requiring any special skills of the user, and without facing the above list of drawbacks.

The prior art does not teach or suggest such a solution.

### SUMMARY OF THE INVENTION

A multiple legged nail and multiple legged nail system according to at least some embodiments of the present invention includes a multiple legged nail, with the shape of the legs ensuring that when inserted into a panel such as a wood or plaster panel, in which the legs optionally bend outwards, inwards, or a combination of inwards and outwards.

A good grip of the board is thus achieved while keeping the nail at the desired angle relative to the panel.

The multiple legged nail insertion device enables insertion of the multiple legged nail with ease and precision, and without incurring damage to the nail.

The nail and insertion device ensure perpendicular insertion of the multiple legged nail insertion to a plate without bending of the nail before and during the insertion. A tight grip is ensured even if the plate or wall is made of a soft material or of multiple layers. The nail's length is not critical even in case of a plate bundle because any excess length can be easily bent backward toward the back side of the last plate, an operation that would also enhance the grip strength of the nail.

Additional details and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1a of the prior art is a side view schematic illustration of the standard practice of inserting a nail into a wood panel.

FIG. 1b of the prior art depicts how a regular nail might bend due to a slight deviation of the axis of force from the hit by the hammer with regard to the nail's axis.

FIG. 1c of the prior art depicts a case of a multiple layer plate or board where the last layer is not attached to the other layers when the screw length is too short.

FIG. 1d of the prior art depicts a case of a multiple layer plate or board where a screw that is too long protrudes from the last layer.

FIG. 2a is a lower isometric view illustration of an illustrative, exemplary embodiment of a multiple legged nail and multiple legged nail insertion device system, according to the present invention

FIG. 2b is an upper isometric view illustration of an illustrative, exemplary embodiment of a multiple legged nail and multiple legged nail insertion device system, according to the present invention upon which the section plane 7a-7a is marked.

FIG. 3a is an upper isometric view illustration of an illustrative, exemplary embodiment of a multiple legged nail, according to the present invention.

FIG. 3b is a bottom view illustration of an illustrative, exemplary embodiment of a multiple legged nail, according to the present invention.

FIG. 3c is a side view illustration of an illustrative, exemplary embodiment of a multiple legged nail, according to the present invention.

FIG. 3d is a top view illustration of an illustrative, exemplary embodiment of a multiple legged nail, according to the present invention.

FIG. 3e is a side view illustration of an illustrative, exemplary embodiment of two legs, according to the present invention.

FIG. 4a is a bottom view illustration of an illustrative, exemplary embodiment of a handle, according to the present invention.

FIG. 4b is a part of cross sectional view 7a-7a illustration of an illustrative, exemplary embodiment of the handle, according to the present invention.

FIG. 5a is a bottom view illustration of an illustrative, exemplary embodiment of a cylindrical guide, according to the present invention.

FIG. 5b is a part of cross sectional view 7a-7a illustration of an illustrative, exemplary embodiment of the cylindrical guide, according to the present invention.

FIG. 5c is an upper isometric view illustration of an illustrative, exemplary embodiment of the cylindrical guide, according to the present invention.

FIG. 6a is a bottom view illustration of an illustrative, exemplary embodiment of an internal hammer, according to the present invention.

FIG. 6b is a part of cross sectional view 7a-7a illustration of an illustrative, exemplary embodiment of the internal hammer, according to the present invention.

FIG. 6c is an upper isometric view illustration of an illustrative, exemplary embodiment of the internal hammer, according to the present invention.

FIG. 7a is a cross sectional view 7a-7a illustration of an illustrative, exemplary embodiment of a multiple legged nail and multiple legged nail insertion device system, according to the present invention, upon which detail A is marked in a circle, and detail B is marked in an oval.

FIG. 8 illustrates an option for bending the protruding leg tips of multiple legged nail back.

FIG. 9 illustrates another optional embodiment of a multiple legged nail according to the present invention for use with a plate or other support.

FIG. 10 shows the nail of FIG. 9 in an exemplary, illustrative use thereof.

FIG. 11 shows a cross-section of the nail of FIG. 9 in an exemplary, illustrative use thereof.

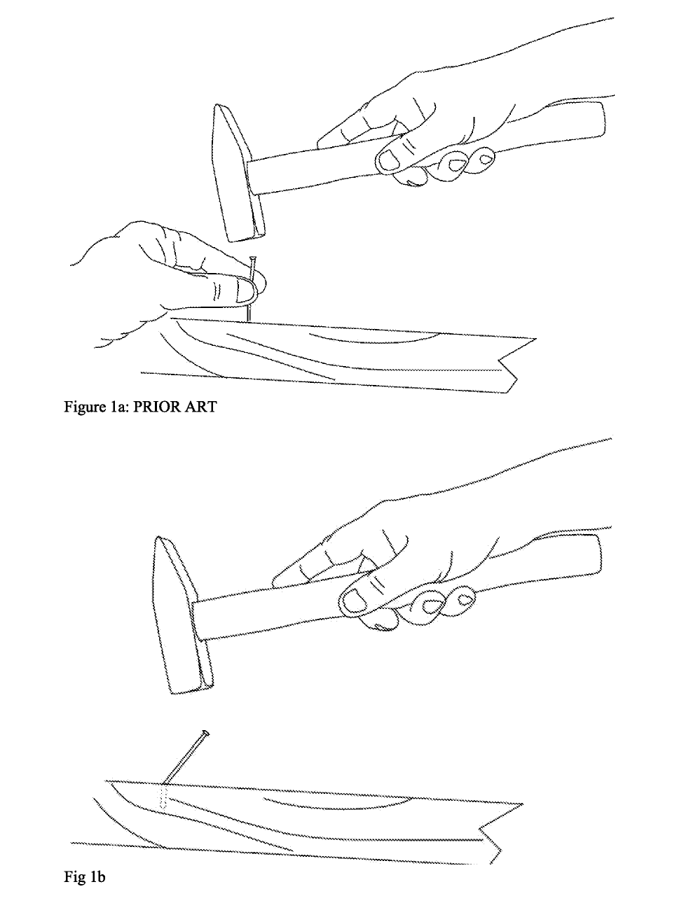

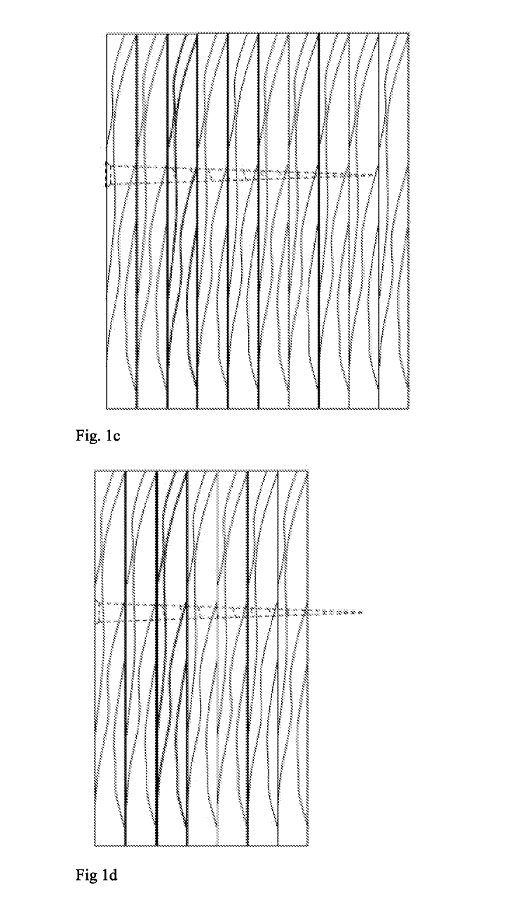

### DETAILED DESCRIPTION OF EMBODIMENTS

The principles and operation of a multiple legged nail and of a multiple legged nail system according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
11 leg
11o leg outer side
11i leg inner side
12 leg tip
13 leg slope
14 shoulder disc
14a cut cone
15 neck
16 head
17 hole
18 jag
22 internal hammer
22a peripheral gradation
22b outer flexible cylinder
22c peripheral teeth
23 cylindrical guide
24 handle
24a first peripheral niche
24b second peripheral niche
25 auxiliary rigid shim
30 plate
100 multiple legged nail
200 multiple legged nail insertion device
300 multiple legged nail and multiple legged nail insertion device system

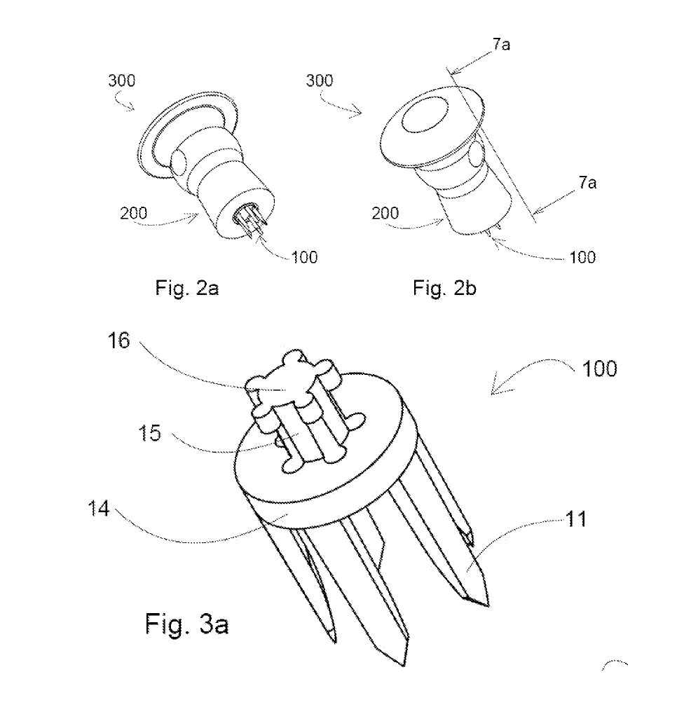

Referring now to the drawings, FIG. 2a is a lower isometric view illustration of an illustrative, exemplary embodiment of a multiple legged nail and multiple legged nail insertion device system 300, according to the present invention.

The present illustration shows a multiple legged nail 100, shown partially within a multiple legged nail insertion device 200.

FIG. 2b is an upper isometric view illustration of an illustrative, exemplary embodiment of a multiple legged nail and multiple legged nail insertion device system 300, according to the present invention, upon which the section plane 7a-7a is marked.

The present illustration shows a multiple legged nail 100, which is partially within a multiple legged nail insertion device 200.

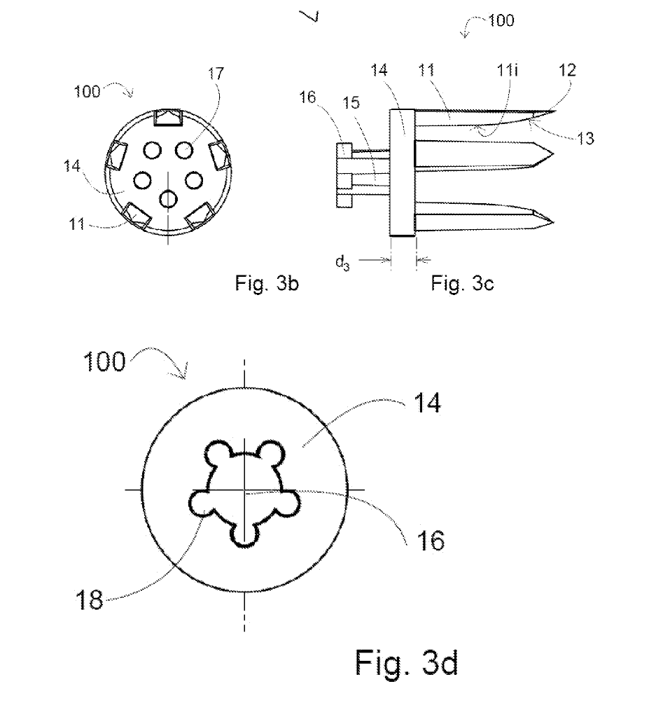

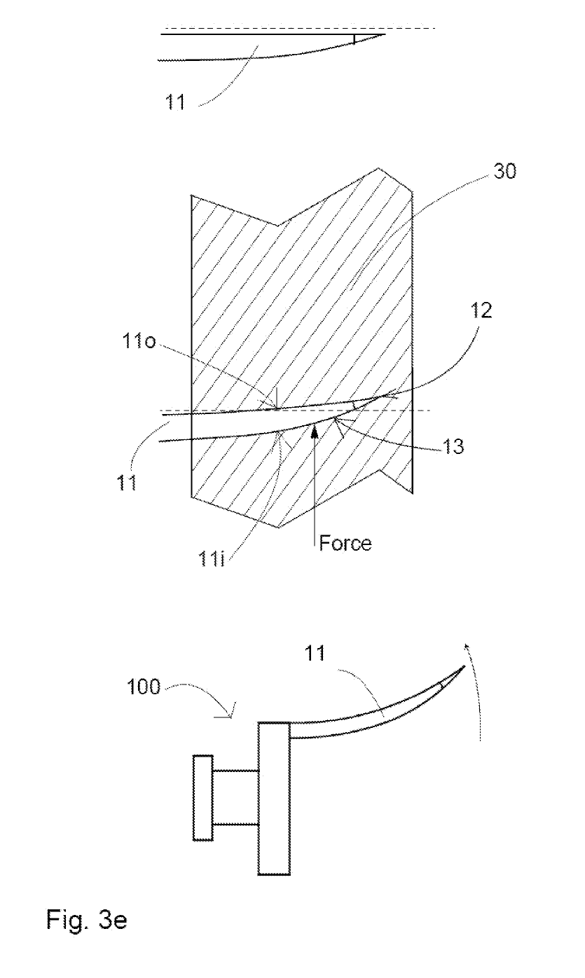

FIG. 3a is an upper isometric view illustration of an illustrative, exemplary embodiment of a multiple legged nail 100, according to the present invention.

The multiple legged nail 100 can be a single unit composed of materials such as plastic, soft metal, or a combination thereof, or any other material which enables leg 11 to bend when being inserted into a board, as will be described in the following description of FIG. 3e. Legs 11 may optionally be finished with any type of finishing surface and/or material, including but not limited to polished, roughened, knurled or any suitable coating.

All the legs 11 protrude from one side of a shoulder disc 14. On the other side of the shoulder disc 14, as shown in the present illustration, is optional neck 15 at the end of which is optional head 16, a structure which enables hanging a load upon the multiple legged nail 100. The multiple legged nail 100 also has the ability to withstand pulling forces, for example, it can hold a rectangle that has a cantilever beam sticking out from it.

The shoulder disc 14 also serves as the part of the multiple legged nail 100 which is hit by hammer (22) when performing insertion. When the purpose of multiple legged nail 100 is to connect panels or any such similar purpose, and when there is no need to hang a load upon it, a multiple legged nail 100 without neck 15 and head 16 can be used.

Head 16 can conform in shape and dimensions to a certain purpose, for example, head 16 can be smaller than a certain triangle that is often found in the back of pictures for hanging.

FIG. 3b is a bottom view illustration of an illustrative, exemplary embodiment of a multiple legged nail 100, according to the present invention. The present illustration shows a multiple legged nail 100 with five legs 11 all disposed upon the same circle, upon which they are equally distributed. This illustration does not in any way limit the present invention to a multiple legged nail 100 of necessarily five legs, as various numbers of legs are optionally used as long as at least a plurality of legs is used. For example, optionally at least two, preferably at least three, more preferably at least four and most preferably at least five legs are present.

The present illustration shows five holes 17. These holes are meant to simplify the mold used in the manufacturing process of multiple legged nail 100, since the extraction from the mold is only in two opposite directions and there are no undercuts, thus no need for a third and fourth direction of extraction of the mold. In cases in which multiple legged nail 100 is manufactured using a different method, there may be no holes 17, or a different number of holes 17 for example according to the number of legs

FIG. 3c is a side view illustration of an illustrative, exemplary embodiment of a multiple legged nail 100, according to the present invention. Each leg 11 has a pointed leg tip 12 which enables easy penetration into panels, and an adjacent leg slope 13 on the leg's inner side 11i. Shoulder disc 14 has a thickness dimension marked in the present illustration as d₃.

FIG. 3d is a top view illustration of an illustrative, exemplary embodiment of a multiple legged nail 100, according to the present invention.

The present illustration shows five jags 18, on the perimeter of head 16. Jags 18 are designated to hold something so it will not slip off (for example the rope in the back of a picture). Jags 18, in their shape and quantity, are one possible embodiment of many for the shape of the perimeter of head 16.

FIG. 3e is a side view illustration of an illustrative, exemplary embodiment of legs 11, according to the present invention. The upper part of the illustration shows leg 11 in its original form prior to being inserted into the board, while the middle part of the illustration shows leg 11 which has been deformed when inserted into the board. The deformation is bending towards the leg's outer side 11o. This is a desired bend achieved as a result of a force component activated on the leg's inner side 11i in the area of leg slope 13 by plate 30.

The lower part of the illustration shows leg 11 of a multiple legged nail 100 in its final bending state after being inserted into plate 30 (not shown in this part of the illustration).

Bending of leg 11 can be achieved in other directions, and particularly inwards, by manufacturing it with other suitable slopes.

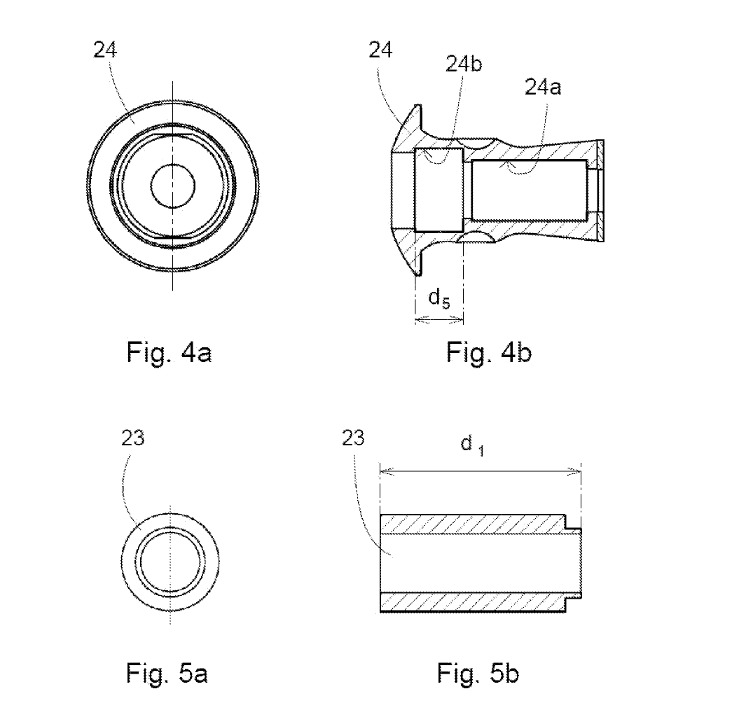

FIG. 4a is a bottom view illustration of an illustrative, exemplary embodiment of handle 24, according to the present invention.

FIG. 4b is a part of cross sectional view 7a-7a illustration of an illustrative, exemplary embodiment of the handle 24, according to the present invention.

Handle 24 has an external shape designed for convenient holding in a person's hand. In the case described in the present illustration, the shape resembles that of a mushroom, which helps to prevent the user's fingers from being hit by the internal hammer (22).

Handle 24 optionally and preferably comprises an external cylinder of the multiple legged nail insertion device 200, and it includes first peripheral niche 24a which corresponds in shape and dimensions to the shape and dimensions of the cylindrical guide (23), not shown in the present illustration. In addition, handle 24 also includes a second peripheral niche 24b, whose length is d₅.

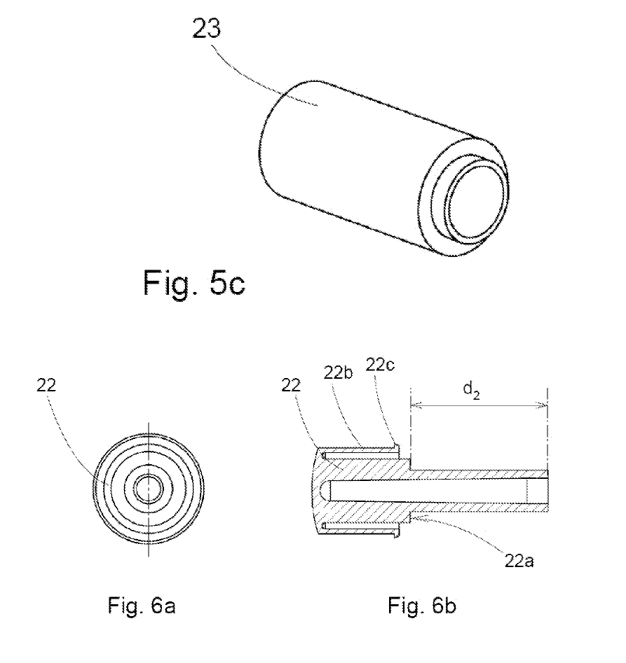

FIG. 5a is a bottom view illustration of an illustrative, exemplary embodiment of cylindrical guide 23, according to the present invention.

FIG. 5b is a part of cross sectional view 7a-7a illustration of an illustrative, exemplary embodiment of cylindrical guide 23, according to the present invention.

The overall length of cylindrical guide 23 is d₁ and its external shape and dimensions preferably correspond to the shape and dimensions of the handle 24.

FIG. 5c is an upper isometric view illustration of an illustrative, exemplary embodiment of the cylindrical guide 23, according to the present invention.

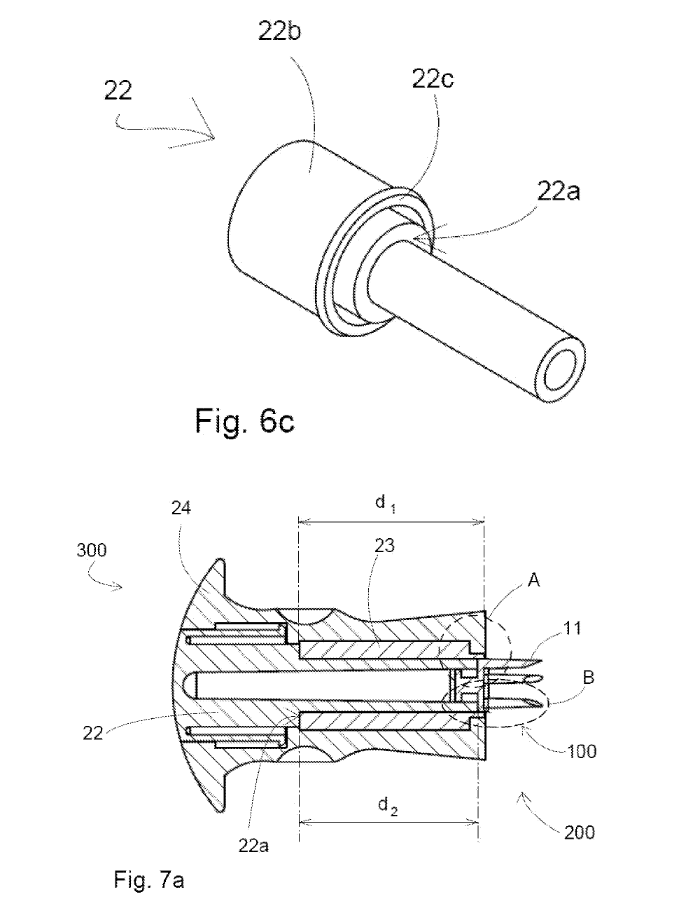

FIG. 6a is a bottom view illustration of an illustrative, exemplary embodiment of internal hammer 22, according to the present invention.

FIG. 6b is a part of cross sectional view 7a-7a illustration of an illustrative, exemplary embodiment of the internal hammer 22, according to the present invention. Its right hand part, as shown in the present illustration, preferably has a constant external radius for its entire length, from the right end to the peripheral gradation 22a. Its length is d₂, and it serves during the insertion of multiple legged nail 100 to conduct the necessary force from the shoulder disc (14) of the multiple legged nail 100. On the other side, the left hand side as shown in the present illustration, of the internal hammer 22, is outer cylinder 22b, at whose right end, as shown in the present illustration, is a peripheral tooth 22c, to engage with the second peripheral niche (24b), and thus enable the limited linear movement of the internal hammer (22) relative to handle 24 whose length is equal to d₅.

FIG. 6c is a upper isometric view illustration of an illustrative, exemplary embodiment of the internal hammer 22, according to the present invention.

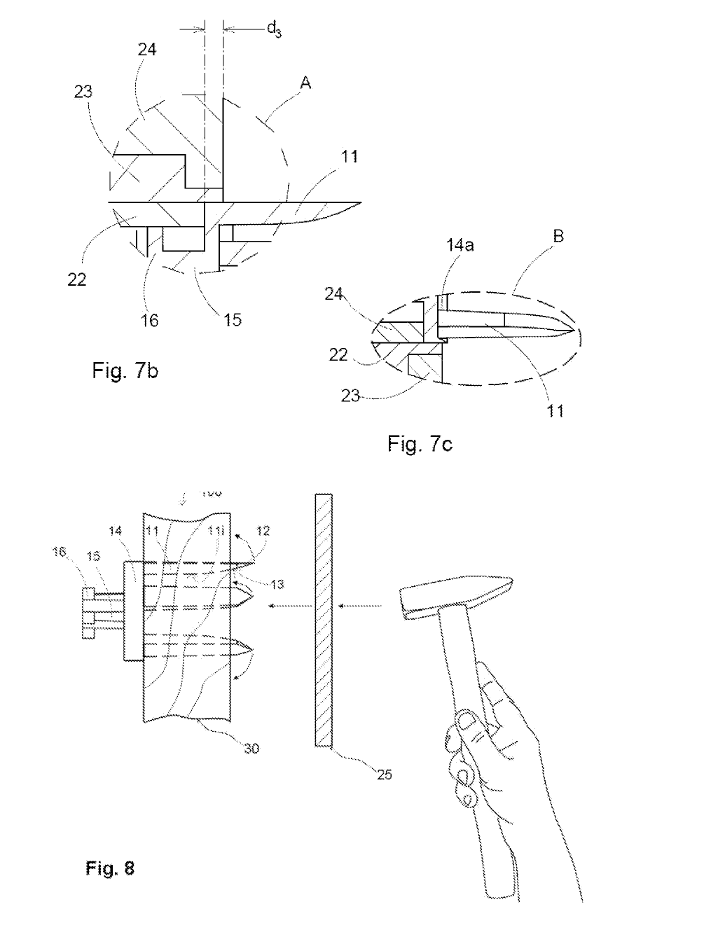

FIG. 7a is a cross sectional view 7a-7a illustration of an illustrative, exemplary embodiment of a multiple legged nail and multiple legged nail insertion device system 300, according to the present invention.

The illustration marks detail A in a circle, which is magnified in the circle on FIG. 7b, and detail B in an oval, which is magnified in the circle on FIG. 7c, according to at least some embodiments of the present invention.

The present illustration shows a multiple legged nail 100, partially within a multiple legged nail insertion device 200, while its legs 11 protrude from the multiple legged nail insertion device 200.

Multiple legged nail insertion device 200 also includes handle 24, which is preferably cylindrical and comprises an external casing, in which is the internal hammer 22, which is partially within cylindrical guide 23 and which can move within in linear movement.

The view shown in the present illustration shows that the internal hammer 22 is preferably limited in movement to the right by the contact of its peripheral gradation 22a at the end of cylindrical guide 23.

The handle 24 can be made of soft material, such as rubber, while the cylindrical guide 23 and the internal hammer 22 are made of rigid materials, and are inserted in to handle 24 with force.

FIG. 7b is a magnified detail A in a circle, according to at least some embodiments of the present invention. The formal structure and particularly the dimension ratios of the handle 24, the cylindrical guide 23, and the internal hammer 22 ensure that the right end, as shown in the view of the present illustration, of the internal hammer 22 cannot be in close proximity to the right end, as shown in the present illustration, of the handle 24, as its diameter is smaller than d₃, thus ensuring that the internal hammer 22 will not crush the shoulder disc 14 of the multiple legged nail 100 when there is contact between the shoulder disc 14 and the board into which it is inserted, at the end of the insertion process.

FIG. 7c is a magnified detail B in an oval, according to at least some embodiments of the present invention. The present illustration shows one possible structure of various possibilities for the formal structure of the shoulder disc 14. In this case, its right part, as shown in the present illustration, has a niche in the shape of cut cone 14a.

The purpose of the cut cone 14a is to conceal any gap between the nail and the wall that may have been formed in cases such as insertion at a slight angle or the wall is not completely straight.

FIG. 8 illustrates a case where nail legs 11 are longer than the thickness of plate 30 into which multiple legged nail 100 is inserted. Multiple plates are depicted in the drawing as a general case. The protruding leg tips can be easily bent backward toward the rear surface of the plate bundle by either directly hitting them with a standard hammer or by using an auxiliary rigid shim 25 as a mediator between the hammer and the leg tips. This bending of the leg tips obviates the need for an accurate matching of the leg length and the plate thickness. The described bending also increase the strength of the resulting connection between the plates.

Rigid shim 25 may optionally have for example a square or a round shape, is optionally and preferably approximately a few mm in thickness and is optionally made of any rigid material—for example and without limitation, metal, wood or plastic.

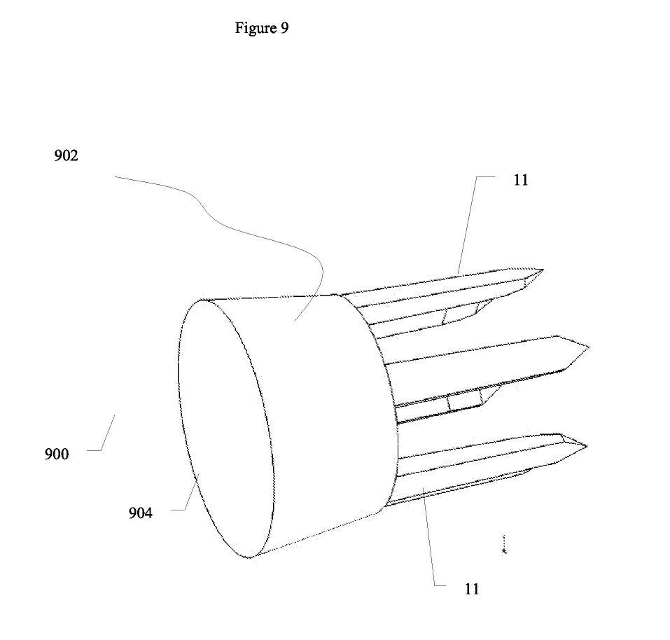

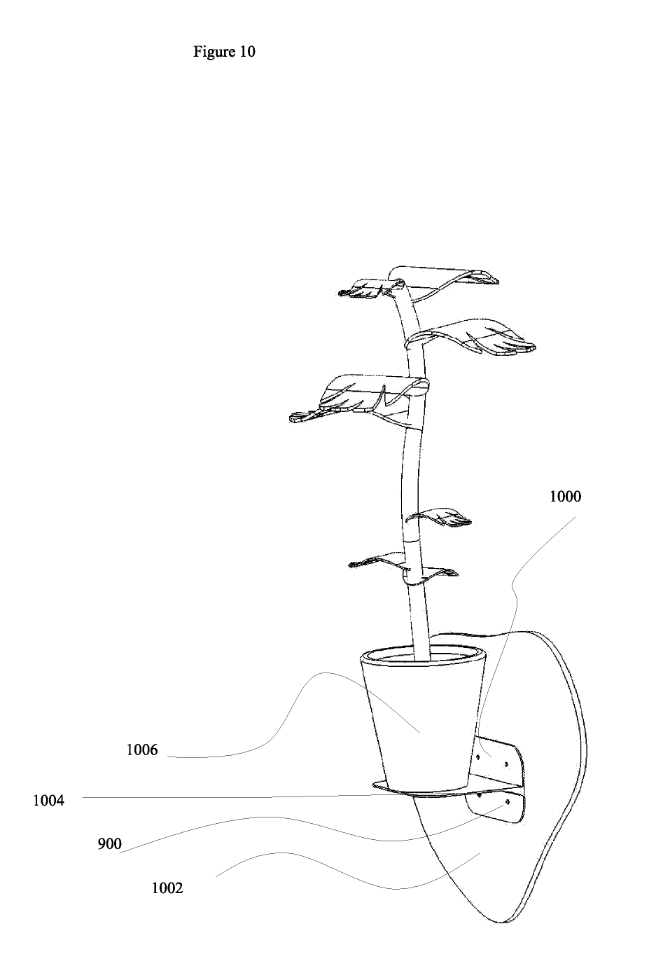

FIG. 9 illustrates another optional embodiment of a multiple legged nail according to the present invention with a conical head (shoulder disc). As shown, a multiple legged nail 900 optionally and preferably features a shoulder disc 902, to which a plurality of legs 11 are attached as previously described. Shoulder disc 902 preferably features a supporting surface 904, for example for being inserted through a plate or other support. Shoulder disc 902 may optionally be conical as shown.

FIG. 10 shows the nail of FIG. 9 in an exemplary, illustrative use thereof. As shown a plurality of multiple legged nails 900 are preferably inserted through a plate 1000. Although four such multiple legged nails 900 are shown as being inserted through plate 1000, optionally any number of such nails 900 may be so inserted (i.e. 1, 2, 3, 4, 5, 6, 7 or 8, or more and so forth, optionally and preferably according to the load to be supported). Nails 900 are inserted through plate 1000 into a wall 1002 as previously described. Plate 1000 is shown in this non-limiting example as preferably supporting a bracket 1004, which in turn may optionally support any type of heavy load 1006.

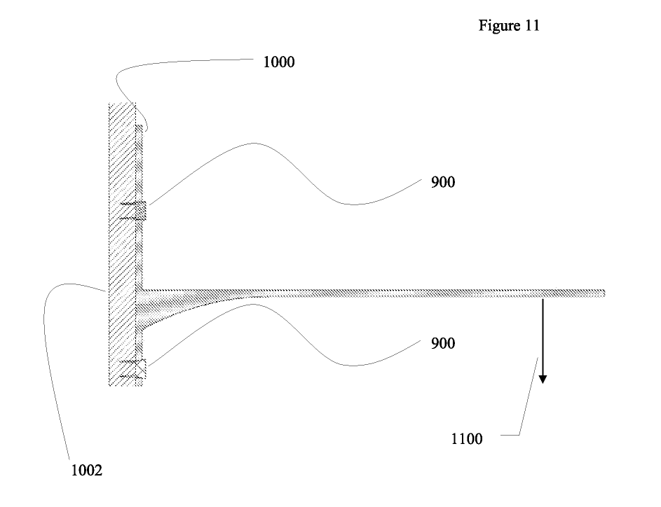

FIG. 11 shows a cross-section of the nail of FIG. 9 in an exemplary, illustrative use thereof. As shown, a plurality of nails 900 are inserted through plate 1000 into wall 1002 as previously described. An arrow 1100 shows the direction of the load force.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is specifically noteworthy that the shape and dimensions of the various components of the multiple legged nail (100) can be made to conform specifically for various designations, such as varying weights to be supported, composing materials, and the width of plate (30), into which it is supposed to be inserted. Thus, the number of legs (11), their length, and the shapes and dimensions of the neck (15) and the head (16) can be changed as necessary.

1. A multiple legged nail comprising:
(a) a shoulder disc, having a first plane and a second plane; and
(b) at least two legs disposed on said first plane of said shoulder disc.

2. The multiple legged nail of claim 1, wherein each one of said at least two legs has a leg tip and a leg slope, said leg tip adapted for penetrating a material.

3. The multiple legged nail of claim 2, wherein said leg comprises a flexible material for enabling said leg to bend.

4. The multiple legged nail of claim 3, wherein said flexible material comprises one or more of plastic or metal, or a combination thereof.

5. The multiple legged nail of claim 4, wherein said leg is finished with a suitable finishing surface and/or material.

6. The multiple legged nail of claim 5, wherein said finishing surface is polished, knurled or roughened, or coated with a suitable coating.

7. The multiple legged nail of claim 2, wherein said legs are distributed equidistantly on said first plane of said shoulder disc.

8. The multiple legged nail of claim 7, further comprising at least one hook disposed on said second plane of said shoulder disc.

9. The multiple legged nail of claim 8, wherein said shoulder disc further comprises a cut cone.

10. The multiple legged nail of claim 2 further comprising:
(c) a neck disposed on said second plane of said shoulder disc.

11. The multiple legged nail of claim 10 further comprising:
(d) a head disposed on said neck.

12. The multiple legged nail of claim 11, further comprising at least one jag on said head.

13. The multiple legged nail of claim 12, wherein said at least one jag comprises a plurality of jags.

14. The multiple legged nail of claim 1, wherein said second plane has a conical shape.

15. A multiple legged nail system comprising the multiple legged nail of claim 11 and further comprising a multiple legged nail insertion device comprising a static part for gripping said head and a movable part that is connected to said static part, wherein both said static and movable parts are concentered around a longitudinal axis of said multiple legged nail, and wherein said movable part is adapted for applying force on said head along said common longitudinal axis.

16. The multiple legged nail system of claim 15 wherein said insertion device further comprises:
(a) a cylindrical handle, said handle having a first peripheral niche and a second peripheral niche;
(b) a cylindrical guide mounted partially inside said first peripheral niche of said handle; and
(c) an internal hammer mounted partially inside said handle and partially inside said cylindrical guide.

17. The multiple legged nail system of claim 16, wherein said internal hammer has a peripheral gradation, and wherein said cylindrical guide, limits linear movement of said internal hammer inside said handle, when said peripheral gradation of said internal hammer comes in contact with said cylindrical guide.

18. A multiple legged nail support system, comprising a plurality of multiple legged nails according to claim 1; and a support for a load, said support comprising a plate, said plate comprising a plurality of holes for receiving said plurality of multiple legged nails.

19. A multiple legged nail insertion system for a standard hammer, comprising said multiple legged nail of claim 2 and an auxiliary rigid shim, said shim being adapted for use as a mediator between said standard hammer and the leg tips of said multiple legged nail, wherein said standard hammer is used for bending said tips backward toward a plate or a plate bundle into which said multiple legged nail has been inserted.
